(19) United States
(12) Patent Application Publication
(10) Pub. No.: US 2003/0083413 A1
(43) Pub. Date: May 1, 2003

(54) Thermoplastic adhesive

(76) Inventor: William C Stumphauzer, Elyria, OH (US)

Correspondence Address: Paul E Milliken, 9061 Wall Street N W, Massillon, OH, 44646-1676, US

(21) Appl. No.: 10/181,903

(22) PCT Filed: Jan. 19, 2001
(86) PCT No.: PCT/US01/01907

(51) Int. Cl. C08K 5/09

(52) U.S. Cl. 524/296; 524/563; 524/432; 524/444; 524/495

(57) ABSTRACT

A heat-activated thermoplastic material for forming an adhesive is formed from an admixture of a thermoplastic resin in a liquid carrier. The admixture is a liquid slurry at room temperature that undergoes a change in which the slurry becomes pasty upon heating to a fusion temperature and liquefies upon further heating to form a pumpable molten liquid. The molten liquid hardens as it cools to form an adhesive. The cooled, hardened adhesive is reheatable to return to a liquid state. An apparatus for applying the adhesive is also disclosed.

### BACKGROUND OF THE INVENTION

The present invention pertains to a thermoplastic adhesive. More particularly, the present invention pertains to a thermoplastic adhesive that is flowable at room temperature, and remains flowable through heat-up, up to and at application temperature. The invention further pertains to an apparatus for applying such a thermoplastic adhesive.

Hot melt adhesives are widely used in most every industry today. These adhesives are used to bond together a broad ranges of substrates and products. One advantage of hot melt adhesives is that they solidify rapidly to create functional adhesive bonds generally within seconds of being dispensed from a hot melt applicator.

Typically, hot melt adhesives are 100% solids thermoplastics that are solid at room temperature and become flowable liquids at elevated temperatures. These temperatures typically range from about 300° F. to about 400° F., within which range the adhesives are sufficiently flowable to be expelled from applicator equipment. When applied as a hot liquid to a substrate, heat is rapidly drawn from the hot melt by the bonded substrate. Thus, rapid solidification of the hot melt occurs and a relatively fast adhesive bonding of the substrates results.

In addition, hot melts can be specifically formulated for use as caulks, sealants and gasket materials. These materials have the desirable characteristic, vis-á-vis these particular applications, in that they become almost immediately functional because they solidify quickly after being dispensed as a molten liquid. Hot melt adhesives may also be formulated and dispensed as foams providing the further advantage of forming compressible seals with insulative and acoustic attenuation properties. However, as noted below, hot melts do not provide a wide range of application possibilities when applied as foams.

Hot melt adhesives do, however, have their drawbacks. First, because of their solid-phase room temperature characteristics, these adhesives must be heated and melted in complex applicator equipment. Typically, this equipment includes melting and holding tanks, heated pumps, heated hoses and heated dispensing heads. The equipment requires expensive and extensive maintenance in order to assure proper functionality. In particular, the adhesive must be maintained at a sufficiently elevated temperature in order to remain in a liquid state. To this end, significant operating costs are encountered due to the heat consumption of the equipment necessary to maintain the adhesive in a liquid state. In addition, because the equipment must be maintained at elevated temperatures, it has been found that the costs associated with parts replacement can become a considerable part of the overall operating costs for this type of system.

It has also been found that many of the polymeric materials that are used to formulated hot melt adhesives tend to degrade when they are held at high temperatures for prolonged periods of time. As these materials degrade within the heated applicator equipment, not only do they lose many of their advantageous physical and adhering properties, but they can also char, causing solidified residues, i.e., char particle contaminants, to plug filters and dispensing heads. This typically results in decreased production time and ultimately stopping production line operation.

Many hot melt adhesives, which flow readily at temperatures of about 300° F. to 350° F., have relatively low molecular weights compared to higher molecular weight compositions that are melted in extruders (at temperatures of about 425° F. to 550° F.). These low molecular weight thermoplastics are not as strong as the higher molecular weight extruded materials. As such, lesser performance characteristics can include lower tensile strength, lower elongation before break, low tensile modulus, and less compression set resistance. To this end, most hot melt adhesives are generally not particularly well-suited for high performance bonds, caulks, sealants or gaskets. In addition, the physical properties of hot melt adhesives decrease significantly when applied as a foam. In fact, the cross-sectional strength, tensile, modulus and compression set characteristics have been shown to decrease such that hot melt adhesive foams have extremely limited functional utility.

Nevertheless, because hot melt adhesives form functional adhesive bonds quickly upon application, they are used extensively in high-speed production lines. For example, hot melt adhesives are used for consumer packaging and bonding of paper products such as cartons, boxes, corrugated cases, non-woven products and the like.

Also known are “cold glues” for use in consumer packaging applications. Typically, these cold glues are liquid emulsion adhesives that set and cure by the removal (e.g., evaporation and/or substrate absorption) of water from the emulsion. In common cold glue formulations, water is the primary carrier liquid for the emulsion. To this end, it has been found that these adhesives do not provide the adhesive strength almost immediately upon dispensing as compared to hot melt adhesives. This is due in part to the necessity for the removal of water from the liquid emulsion in order to form these bonds. As such, high-speed production cannot be achieved using these cold glues.

To this end, in order to accelerate the time for the setting of these emulsion adhesives, radio frequency dielectric heating in which electromagnetic fields in the range of about 10 to about 20 megahertz (MHz) has been attempted. In this process, the application of the radio wave frequencies heats the emulsions and evaporates water through the excitation of the polar water molecules. This process also requires considerable amounts of energy because of the water that must be evaporated from the emulsion for the adhesive to set. In addition, in order to achieve rapid adhesive setting (i.e., short set times) high concentrations of radio frequency power are required. It has been found that these high concentrations of radio frequency power also heat the underlying substrate, e.g., paperboard packaging, and may heat the substrate to temperatures sufficiently high to cause discoloration and possible combustion of the substrate product.

Another type of adhesive, commonly known as plastisol is a resin suspension, typically of polyvinyl chloride (PVC) resin in plasticizers that are liquid at room temperature and fused to a 100% solids thermoplastic when heated to about 325° F. to about 375° F. and subsequently cooled to at a solid at room temperature. Typically, plastisols are used for nylon coating, linoleum top coating, carpet backing and bonding to aluminum, glass, fabric, and sheet metal.

While plastisols work well for their intended purpose, they are typically not used as adhesives for high speed bonding of, for example, paper products or packaging. Plastisols are not used in this type of bonding scenario in that it has been found to be quite difficult to heat them from room temperature liquids to molten thermoplastic adhesives in the short time available (seconds or milliseconds) required for high-speed bonding processes.

In addition, plastisols are typically unusable in conventional hot-melt applicator equipment. During use this equipment may maintain the adhesive material at elevated temperatures (e.g., above about 300° F. to 350° F.) for prolonged and unpredictable periods of time. When subjected to these longer periods of elevated temperatures, plastisols become unstable and degrade. Once degradation begins, it can rapidly accelerate throughout the material. Thus, because conventional hot-melt applicators cannot limit or control the heat history of the materials used therein, these applicators are not well suited for applying plastisol materials.

In addition, plastisols do not proceed through physical phase changes in the same manner as hot-melt adhesives. As hot-melt materials are heated, they go through typical phase changes from solid to softening to liquid, with viscosity decreasing throughout heating. On the other hand, as plastisols, which are liquid at room temperature, are heated, the viscosity decreases. As the temperature increases, the composition converts to a solid (referred to as a gel). Upon further heating, to fusion temperature and above (about 300° F. to 350° F.), plastisols become a highly viscous molten thermoplastic. The phase change as heated from liquid to solid to unstable viscous liquid makes these compositions unsuitable for use in conventional hot-melt application equipment.

Accordingly there exists a need for a thermoplastic adhesive that is flowable at room temperature and attains its adhesive properties after it cools from an elevated temperature. Preferably, such an adhesive remains flowable from room temperature through heat-up, up to and at application temperature. Most preferably, such a thermoplastic adhesive can be heated quickly for use as a molten adhesive with rapid set bonding characteristics similar to those of hot-melt adhesives.

### BRIEF SUMMARY OF THE INVENTION

A heat-activated thermoplastic material for forming an adhesive is an admixture of a thermoplastic resin in a liquid carrier. The admixture is a liquid slurry at room temperature that undergoes a change in which the slurry becomes pasty upon heating to a fusion temperature and liquefies upon further heating to form a pumpable molten liquid. The molten liquid hardens as it cools to form an adhesive. The cooled, hardened adhesive being reheatable to return to a liquid state.

A preferred thermoplastic resin is a copolymer of polyvinyl chloride and vinyl acetate. In a current formulation, polyvinyl chloride is present in the thermoplastic resin in a concentration of about 85 percent and vinyl acetate is present in a concentration of about 15 percent, and the thermoplastic resin has a relative viscosity of less than about 1.8.

Alternately, the thermoplastic resin is a copolymer of polypropylene or polyethylene.

The carrier liquid can be a non-volatile liquid such as diisodecyl phthlate, diisodecyl adipate, dinonyl phthlate, dioctyl phthlate, tricresyl phosphate and dioctyl adipate. Preferably, the carrier liquid is diisodecyl phthlate. The thermoplastic resin is present in a concentration of about 60 percent by weight of the slurry, and the carrier liquid is present in a concentration of about 40 percent by weight of the slurry.

The thermoplastic material can include additives, such as carbon fiber, calcium carbonate, stabilizers, wetting agents, tackifiers, foaming agents or plasticizers. Small amounts of ground hot-melt adhesive can also be added to the material to improve the adhesion characteristics.

In one formulation, the thermoplastic material includes electromagnetic receptor particles admixed with the thermoplastic resin and the liquid carrier. The receptor particles can be ferromagnetic particles, zinc oxide, fumed silica, magnesium aluminum silicate, graphite, carbon black or conductive metal powder. In this formulation, the liquid carrier can be a thermally conductive liquid. Preferably, the thermally conductive liquid is formed from polar molecules and the thermoplastic resin is formed from polar molecules.

The receptor particle containing formulation can be heated by a high frequency electromagnetic field.

An apparatus for dispensing and activating the receptor particle containing heat-activated thermoplastic material, includes a reservoir or tank for storing the heat-activated thermoplastic material when in a liquid state and a nozzle for dispensing the heat activated thermoplastic material when in a liquid state.

The apparatus further includes an electromagnetic field generator for generating an electromagnetic field. The generator is disposed downstream of the nozzle so that the electromagnetic field acts on the heat activated material after it is dispensed from the nozzle. When activated, the material becomes pasty upon heating to a fusion temperature and liquefies upon further heating to form a pumpable molten liquid. The molten liquid hardens as it cools to form an adhesive. The cooled, hardened adhesive being reheatable to return to a liquid state.

The apparatus can includes a pump disposed between the tank and the nozzle for conveying the heat-activated thermoplastic material from the tank to the nozzle. A dispensing valve can be disposed between the tank and the nozzle for commencing and terminating flow of the heat-activated thermoplastic material. The dispensing valve can be disposed between the pump and the nozzle.

The apparatus can further include a mixer disposed between the dispensing valve and the pump. The electromagnetic field generator can be a coil.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a schematic illustration of one embodiment of an apparatus for dispensing and activating a heat activated thermoplastic embodying the principles of the present invention;

FIG. 2 is a schematic illustration of an alternate embodiment of a dispensing and activating apparatus embodying the principles of the present invention;

FIG. 3 is a still another embodiment of the dispensing and activating apparatus;

FIG. 4 is a graphical representation of the molten or liquid viscosity along the abscissa measured in centipoise at 350° F. as a function of the plasticizer concentration shown along the ordinate in a concentration of part per hundred resin (PHR), illustrated at various constant resin relative viscosities; and

FIG. 5 is a graphical representation of the molten or liquid viscosity along the ordinate measured in centipoise at 350° F. as a function of varying plasticizer levels in PHR shown along the abscissa, for three different resins having different relative viscosities.

### DETAILED DESCRIPTION OF THE INVENTION

While the present invention is susceptible of embodiment in various forms, there is shown in the drawings and will hereinafter be described a presently preferred embodiment with the-understanding that the present disclosure is to be considered an exemplification of the invention and is not intended to limit the invention to the specific embodiment illustrated. It should be further understood that the title of this section of this specification, namely, “Detailed Description Of The Invention”, relates to a requirement of the United States Patent Office, and does not imply, nor should be inferred to limit the subject matter disclosed herein.

A thermoplastic adhesive in accordance with the principles of the present invention is a flowable liquid at room temperature and remains flowable at elevated temperatures up to application temperature. Advantageously, the thermoplastic adhesive in accordance with the present invention is a flowable liquid at room temperature that can be reheated and re-liquefied (to a flowable liquid) after it has solidified. In this manner, no heating of the adhesive storage and transport or conveying equipment is required.

The thermoplastic adhesive, as a liquid, can be heated immediately prior to dispensing, for example, by a heater located at the dispensing head. Most advantageously, the liquid can be heated quickly, generally, within about two seconds, thus facilitating use in high speed processing lines such that as that used in packaging of consumer goods using paperboard and like substrate packaging.

In one embodiment, the thermoplastic adhesive is a suspension of thermoplastic resin in a liquid. Preferably, the liquid is a thermally conductive liquid. Most preferably, electromagnetic receptor particles are also suspended within the liquid. The liquid carrier may be a plasticizer, such as diisodecyl phthlate (DIDP), diisodecyl adipate (DIDA), dinonyl phthlate (DNP), dioctyl phthlate (DOP), tricresyl phosphate (TCP), dioctyl adipate (DOA) and the like. Other plasticizers will be recognized by those skilled in the art. The thermoplastic resin suspended in the liquid may be, for example, a polyvinyl chloride (PVC) dispersion resin, such as GEON 137, which is a functionally reactive copolymer resin that includes carboxyl functional groups, and which is commercially available from Polyone Corporation (GEON) of Avon Lake, Ohio.

In a preferred embodiment of this formulation, the thermoplastic resin is a highly polar molecule. It has been found that polar molecules can move more freely in liquids. It has also been found that these highly polar molecules, when exposed to high frequency magnetic fields, tend to rapidly twist and reorient themselves in accordance with the electromagnetic fields. This twisting and reorienting motion produces heat within the adhesive. In addition, polar thermoplastic molecules exhibit superior adhesion to non-polar substrates such as coated paperboard and the like. Preferably, the thermally conductive liquid is also formed from polar molecules. Examples of such polar liquids include the above-noted DOA and TCP.

It has been found that admixing and suspending the electromagnetic receptor particles within the thermally conductive liquid can greatly increase the heat-up rate of the thermoplastic adhesive. Without being bound to or limited by the theory of why this is so, it is believed that with these receptor particles mixed therein, two sources of heat generation are created, namely, dielectric and induction heating. Induction heating is produced when the high frequency electromagnetic fields cause electrical currents to flow in and through the conductive particles that, because of their physical size, resist the current flow. The resistance to current flow results in heat-up of the particles due to the flow of electrical current. This heat is rapidly absorbed by the plasticizer and is believed to synergistically act to accelerate the dielectric heating rate. It is believed that the increased temperature of the plasticizer in turn increases the vibration rate of the polar molecules so that they are more responsive to the high frequency electromagnetic fields. In addition, it is believed that this increased temperature (resulting in increased heat) simultaneously softens or melts the outer layer of each resin particle. In this manner, the polar PVC molecules are free to reorient and twist which, in turn, produces frictional heat in response to the high frequency electromagnetic fields.

The following examples illustrate the comparative heat-up rate of a formulation of a thermoplastic adhesive in accordance with the principles of the present invention.

### EXAMPLE 1

Three liquids were measured for their rate of heating in response to microwave fields generated at a frequency of 2,450 megahertz (MHz) and a power level of 800 watts in a conventional, household microwave oven. The mass of each sample was 200 grams. The liquid containers were all identical in dimension and shape, and each sample was placed at the same location in the oven. The duration of exposure to the microwave energy was identical for the liquids of Samples 1 and 2, but had to be reduced for the liquid of Sample 3 when it began to smolder.

Table 1 below illustrates the rate of heat-up of the liquids with simultaneous dielectric and induction heating.

TABLE 1
Comparative Heating Rate

| | Microwave | | | | | |
|---|---|---|---|---|---|---|
| | Exposure | | | | Heat Rise | 1 Gram Heat |
| | Duration, | Degree F. | Degree F. | | 200 Gms | Rise |
| Fluid | (Seconds) | Start Temp | End Temp. | Heat Rise ° F. | ° F./Second | ° F./Second |
| Water | 90 | 60.2 | 114.6 | 54.4 | .6 | 120 |
| (Sample 1) | | | | | | |
| Plastisol | 90 | 66.8 | 112.5 | 45.7 | .5 | 100 |
| “A” | | | | | | |
| (Sample 2) | | | | | | |
| Plastisol | 75 | 70.1 | 325.0 | 250.0 | 3.3 | 660 |
| “A” w/10% | | | | | | |
| Graphite | | | | | | |
| Admix | | | | | | |
| (Sample 3) | | | | | | |

As can be seen from Table 1, the rate of heat-up of the liquids with simultaneous dielectric and induction heating (Sample 3) was at least 5.5 times faster than the rate of heat-up by dielectric heating alone. It is to be noted that the microwave energy of this example was not optimized for use in heating or fusion melting plastisols of the present invention. Specifically, the microwave energy was not focused into a single mode which would otherwise produce more intense and rapid heating. It must also be recognized that the reflection of microwave energy off of the oven walls caused some of the microwaves to be cancelled while others were amplified and some possible absorbed by the magnetron element of the microwave oven. The actual time to achieve fusion melting of plastisol with the receptors admixed therein will, likely, be far less than that shown when the radio frequency energy is focused into a single mode and optimized for this particular purpose.

The above-noted electromagnetic receptor particles are known in the art. Typically, these receptor particles heat-up when they are exposed to high frequency electromagnetic fields. Generally, the heat-up is optimized when the receptor particles are exposed to electromagnetic fields within a specific frequency range.

Electromagnetic field generators are also known in the art. One example of such a generator is, as set forth above, a conventional, household microwave oven. Other generators include power supplies that are readily available today. The range of frequencies produced by these field generators, their power output and electronic circuitry all effect the size and cost of the specific generator. Table 2 below provides a comparison of various, exemplary electromagnetic receptor particles and electromagnetic field generators and approximate costs for operating these generators.

TABLE 2
Electromagnetic Receptor
Additives For Vinyl Plasticizer Suspensions

| | Electro- | | | Commercially |
|---|---|---|---|---|
| Receptor | Magnetic | Heat | Est. Cost/KW | Available Power |
| Material/Size | Frequency | Generation Process | $(000'S) | Supply KW Range |
| Ferromagnetic | 450 KHz to 15 | Electric Current | 8-12 | 1-10 |
| Particles 40-150 | MHz | Induced in | | |
| Microns | | Receptor Generates | | |
| | | Heat | | |
| Zinc Oxide | 15-100 | Di-Electric Heating | 3-6 | 1-10 |
| Fumed Silica | MHz | Polar Molecules & | | |
| Magnesium | | Polar Receptors | | |
| Aluminum | | Reorients Rapidly | | |
| Silicate 20 to 150 | | in Response to RF- | | |
| Microns | | Converting FR to | | |
| | | Thermal Energy | | |
| Zinc Oxide | 900-2,450 | Microwave Di- | 3-4 | 3.0-10 |
| Fumed Silica | MHz | Electric Heating- | | |
| Magnesium | | Polar Molecule | | |
| Aluminum | | Receptors Reorient | | |
| Silicate 20 to 150 | | in Response to | | |
| Microns | | Microwaves | | |
| | | Converting | | |
| | | Microwave Energy | | |
| | | To Heat | | |
| Graphite, Carbon | 900-2,450 | Microwave Di- | .6-2.5 | .8-1.5 |
| Black, | MHz | Electric Heating- | | |
| Conductive | | Polar Molecule | | |
| Metal Powder & | | Plasticizer | | |
| Flake 40-150 | | Reorients, in | | |
| Microns | | Response to | | |
| | | Microwaves | | |
| | | Converting | | |
| | | Microwave Energy | | |
| | | To Heat Combined | | |
| | | With Microwave | | |
| | | Induction Heating | | |
| | | of Receptor | | |
| | | Particles | | |

One exemplary use for the present thermoplastic adhesive is in high speed case sealing in which corrugated boxes are formed and sealed at their flaps. Typically, unsealed cases are conveyed past an adhesive dispensing head that extrudes a room temperature thermoplastic adhesive on to the case flaps. The flaps are then folded down and held in compression against their mating flaps until the adhesive is activated by a high frequency electromagnetic field. Upon activation, the adhesive becomes a fuse-melted thermoplastic that solidifies upon cooling thus bonding the flaps to one another. Alternately, the room temperature thermoplastic may be passed through a high frequency electromagnetic field source that heats and fuse melts the room temperature thermoplastic adhesive as it is being dispensed onto the case flaps.

One presently known method to seal cases is one in which a hot melt adhesive is applied to the case flaps. An exemplary high speed case sealer operates to seal the flaps on forty cases measuring 20″×20″×20″. This corresponds to about 1.1 feet per second of thermoplastic adhesive application. Typical adhesive coverage is about 80% of the length of two of the four box flaps. Thus, each adhesive dispensing head extrudes an adhesive bead measuring about 0.040 inches (40 mils) high and 0.100 inches wide (100 mils) and 16 inches in length in about 1.5 seconds. Those skilled in the art will recognize that adhesive deposition flow rates can vary greatly. Nevertheless, a properly calibrated dispensing head extrudes about 120 milligrams of adhesive per inch. This results in about 1.92 grams of adhesive dispensed in 1.5 seconds or about 1.26 grams of adhesive per second.

A formulation of thermoplastic adhesive in accordance with the present invention was subjected to electromagnetic energy to determine the heat-up time and to determine the temperature based upon a given power output. It was found that a equivalent temperature rise of 660° F. per gram per second PVC suspension was achieved. The preferred temperature rise is based upon raising 200 grams by 200° F. in 75 seconds. It was further found that fusion melting of 1 gram of PVC resin suspension was achieved in about 2.5 seconds using a 1 kilowatt induction power supply commercially available from Ameritherm of Scottsville, N.Y. under equipment model no. 1M NOVASTAR. The PVC resin suspension contained a 10% by weight concentration of 100 micron particle size ferromagnetic powder.

The thermoplastic adhesive of the present invention can also be used to generate foams with blowing agents that activate when the PVC suspensions reach fusion melting temperatures. When applied as a foam, PVC thermoplastic adhesive costs can be reduced by as much as 70%. In addition, because the mass of material to be melted is less, the power requirements and equipment costs are commensurately reduced. One such foaming agent is azodicarbonamide (1-1′-azobisformamide) which is a temperature sensitive foaming agent. This and other foaming agents are commercially available under the name CELOGEN® from Uniroyal Chemical Company, Inc. of Middlebury, Conn.

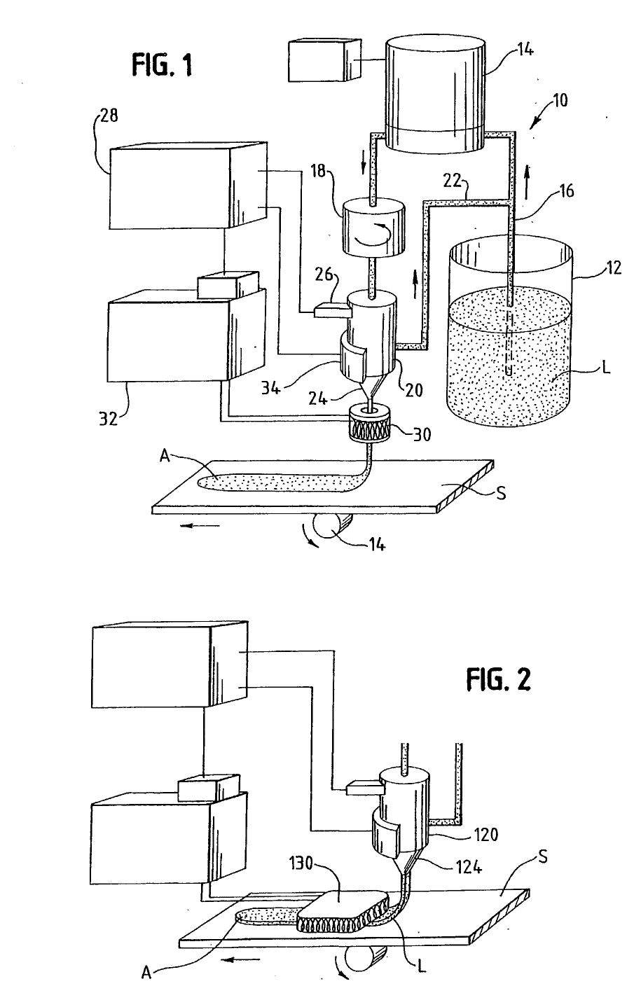

An exemplary apparatus 10 for applying a thermoplastic adhesive in accordance with the present invention is illustrated in FIG. 1. The apparatus 10 includes a storage reservoir such as the illustrated tank 12. The liquid L is stored in the tank 12 and is transferred by a pump 14. In one apparatus 10, the liquid L is drawn by a siphon tube 16 into the pump 14. The liquid L is discharged from the pump 14 through an optional mixer 18 and into a dispensing valve 20. A recirculation line 22 can return undispensed liquid L back to the pump 14 inlet.

The liquid L is extruded through a nozzle 24 when the dispensing valve 20 is opened. The dispensing valve 20 is controlled by a valve actuator 26 that is controlled by a signal from a speed and flow responsive controller 28. The liquid L passes through a high frequency electromagnetic field that is generated by an emitter 30. The emitter 30 is in a fixed relationship relative to the valve 20 and is actuated by a power supply 32.

When the emitter 30 generates the electromagnetic field, the liquid L is heated from room temperature to the fusion temperature, at which it changes or converts to a molten thermoplastic. The molten thermoplastic is deposited onto a substrate S, such as the exemplary carton flaps to provide an application of thermoplastic adhesive A. Alternately, the thermoplastic adhesive A can be deposited to form a gasket. The thermoplastic adhesive A solidifies as it cools to room temperature.

The controller 28 can be configured to receive a signal from a flow sensor 34 when the dispensing valve 20 is opened and the liquid L is flowing through the nozzle 24. In this manner, the emitter 30 will only require energy when the flow sensor 34 provides a signal to the controller 28 that liquid L is flowing. Optionally, the sensor 34 can provide information such as the mass flow of liquid L to the controller 28 and power supply 32, so that the power output and/or frequency of the power supply 32 can be accordingly proportioned to the flow of liquid L. A motion sensor 36 can also be used to provide information regarding the movement of the substrate S to the controller 28 and pump controller for adjusting the liquid L output.

Alternately, as shown in FIG. 2, the emitter 130 can be positioned downstream of the dispensing valve 120 rather than at the valve 120. In this arrangement, the liquid L converts to a molten thermoplastic as it enters the magnetic field downstream of the nozzle 124 and dispensing valve 120, rather than in close proximity to the valve 120 and nozzle 124. As will be appreciated by those skilled in the art, this arrangement provides a benefit in that the heating location, and thus the location at which the liquid L is subjected to electromagnetic energy (to progress through the phases of room temperature liquid to molten liquid) is displaced from any of the liquid transport systems. Thus, the opportunity for the adhesive A to solidify within any of the transport systems is greatly reduced and perhaps fully eliminated.

FIG. 3 illustrates an arrangement in which a sealing member S1, e.g., a box flap, is positioned over the liquid L as it is dispensed on to the substrate S, prior to being subjected to the electromagnetic field. Subsequent to the flaps S, S1 being folded on to one another, the entire structure is subjected to the electromagnetic field and the thermoplastic adhesive A then takes on its adhesive properties.

An alternate formulation of the present thermoplastic adhesive is a liquid slurry at room temperature that, upon heating, undergoes a reaction in which the liquid becomes pasty and, subsequently, upon further heating liquefies. In all states, until it cools to form an adhesive, the thermoplastic adhesive remains sufficiently liquid that it is pumpable. As the thermoplastic adhesive cools from its fusion or activation temperature, it hardens to provide extremely good adhesive properties. Advantageously, the hardened adhesive can be reheated to return to a liquid state.

The slurry is an admixture of generally, a thermoplastic resin and a plasticizer. A preferred thermoplastic resin is a copolymer of polyvinyl chloride (PVC) and vinyl acetate (VA). The copolymer is suspended in a liquid carrier, such as diisodecyl phthalate (DIDP). The PVC is present in a concentration of about 70 percent to about 95 percent of the resin and the VA is present in a concentration of about 30 percent to about 5 percent of the resin. In a present formulation, the PVC is present in a concentration of about 85 percent by weight of the copolymer and the VA is present in a concentration of about 15 percent by weight of the copolymer. The aggregate of the copolymer in the slurry is about 60 percent by weight of the slurry.

It has been found that when vinyl suspension or dispersion resins are polymerized to molecular weights lower than standard molecular weights (e.g., from standard relative viscosities (RVs) of about 2.0. to 2.5 to a RV of about 1.8 or below), the suspensions do not solidify when heated. This is in contrast to plastisols which, as set forth above, solidify to a gel when heated and upon further heating fuse to become highly viscous, unpumpable melts. In addition, is has been found that when one of the constituents of the copolymer is vinyl acetate (VA), the suspension remains liquid through heat up, provided that the RV is less than about 1.8.

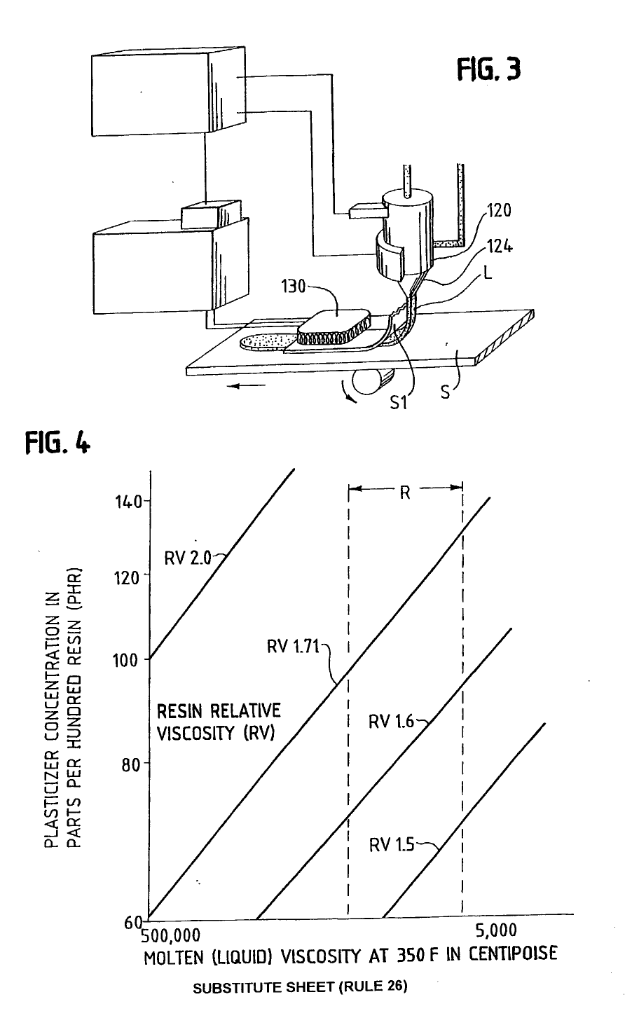

The relative viscosity (RV) of a polymer is one measure of the molecular weight of that polymer; essentially, the relative viscosity is proportional to the molecular weight, and is a critical function that influences the physical change characteristics as the material is heated. Referring to FIG. 4, at any given, constant plasticizer concentration, a lower molecular weight (as shown by the constant RV lines), results in a lower molten or liquid viscosity at fusion temperature. For purposes of the data in FIG. 4, the fusion temperature is assumed to be about 300° F. to 350° F. Conversely, as the RV increases (and thus molecular weight increases), the molten viscosity likewise increases.

It has been found that as plasticizer levels increase over about 120 parts per hundred resin (PHR), the adhesion characteristics of the adhesive resin decrease. The high plasticizer levels result in an adhesive that when cooled is “gummy”, and thus cannot provide the desired adhesive strength. In addition, at plasticizer levels greater than about 100 to 120 PHR, excess plasticizer exudes to the surface of the cooled adhesive over time, destroying its ability to adhere. Thus, a preferred thermoplastic adhesive having characteristics similar to hot-melt adhesives, has a plasticizer level below about 120 PHR and an RV less than or equal to about 1.8.

A present formulation of the adhesive uses a copolymer having a relative viscosity of about 1.58, as equivalent to ASTM D-1243 standards for inherent viscosity. As discussed above, the RV of the copolymer is a function of the molecular weight, e.g., the chain length of the copolymer. The liquid viscosity (as it varies though the entire application temperature range), although not critical, is important for the specific use as an adhesive. This is to assure that the adhesive (prior to cooling and solidification) remains pumpable throughout the heat-up range. The liquid viscosity is also important in that it is a function of the plasticizer concentration, i.e., PHR and the copolymer RV. To this end, a desired liquid viscosity of the molten liquid at fusion temperature is as shown in FIG. 4 in the zone indicated at R. In this zone, the adhesive achieves the desired adhesive properties upon activation and subsequent cooling and is within a liquid viscosity range in which it remains pumpable from room temperature through heat up. Other characteristics of the resin, e.g., particle size, can also affect pumpability.

It is contemplated that the thermoplastic resin can be formed of, in addition to a copolymer of PVC and VA, copolymers of PVC and ethylene vinyl acetate (EVA), copolymers of polyethylene or polypropylene and VA, copolymers of polyethylene or polypropylene and EVA, copolymers of PVC and olefins, copolymers of PVC and acrylonitrile, and copolymers of polyethylene or polypropylene and ethylene acrylic acid (EAA). It is also contemplated that the thermoplastic resin can be formed of various homopolymers, such as PVOH, various terpolymers, such as a PVA/VA terpolymer having a grafted functional acid group, such as acrylic or maleic acid, acrylonitrile-butadiene-styrene (ABS) the like. A terpolymer of PVC/VA/acrylic acid having a concentration of about 1 percent to about 5 percent of the acid group by weight of the terpolymer, has been shown to exhibit increased adhesive characteristics. Such other polymers will be recognized by those skilled in the art.

In a present formulation in which the liquid carrier is DIDP, at fusion temperature the DIDP functions as a plasticizer to form a part of the adhesive. In this manner, it is a non-volatile carrier. That is, it is not driven off by heating the liquid adhesive; rather, it becomes part of the adhesive.

Other non-volatile carrier liquids include, for example, diisodecyl phthlate (DIDP), diisodecyl adipate (DIDA), dinonyl phthlate (DNP), dioctyl phthlate (DOP), tricresyl phosphate (TCP), dioctyl adipate (DOA) and the like. In addition, it is contemplated that water can be used as a carrier, in which case, the water will function as a volatile carrier, in that it will likely be driven off by heating the liquid to fusion temperature.

It is also anticipated that additives can be included in the material such as carbon fiber, or other reinforcements, fillers such as calcium carbonate, stabilizers, wetting agents, tackifiers, plasticizers and the like. To increase the adhesive properties of the solidified thermoplastic adhesive, powdered or finely ground particles of conventional hot-melt adhesive can be added to the liquid adhesive slurry in some instances. As with the previously disclosed formulations, foaming agents, such as azodicarbonamide and the like can be added to create a foamed adhesive.

A present thermoplastic adhesive is a slurry of a copolymer of PVC and VA. Three different PVC/VA copolymers in a liquid carrier of DIDP were sampled to determine the molten viscosity as a function of the plasticizer level (in PHR) in the slurry and the relative viscosity (RV) of the copolymer. For each of the three samples, four different plasticizer levels were used (50, 75, 100 and 125 PHR) The results are provided in Table 3, below. Sample 1 used a copolymer having a RV of 1.60, Sample 2 a RV of 1.46 and Sample 3 a RV of 1.40.

TABLE 3
Liquid Viscosity As Function Of Plasticizer Levels

| | | |
|---|---|---|
| Plasticizer Level (PHR) | Weight % Plasticizer | Viscosity (cp) |

Sample 1

| | | |
|---|---|---|
| 50 | 30.5 | 85,300 |
| 75 | 39.7 | 39,600 |
| 100 | 46.7 | 14,533 |
| 125 | 52.3 | 11,600 |

Sample 2

| | | |
|---|---|---|
| 50 | 30.5 | 60,600 |
| 75 | 39.7 | 27,000 |
| 100 | 46.7 | 16,067 |
| 125 | 52.3 | 11,533 |

Sample 3

| | | |
|---|---|---|
| 50 | 30.5 | 16,667 |
| 75 | 39.7 | 7,267 |
| 100 | 46.7 | 3,267 |
| 125 | 52.3 | 1,260 |

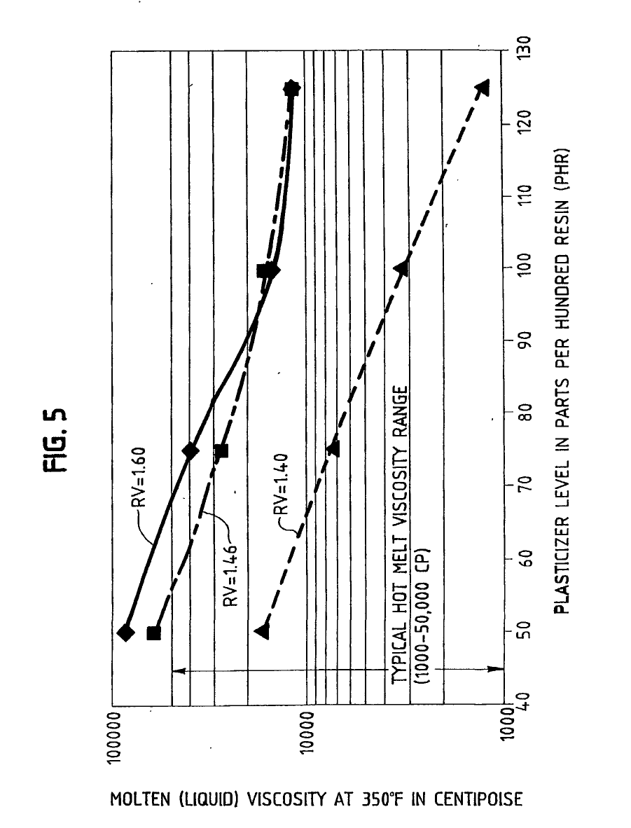

The liquid viscosity (measured as Brookfield viscosity) was measured in centipoise (cp) 350° F., using techniques and equipment that will be recognized by those skilled in the art. Sample 1 was a PVC/VA copolymer commercially available from Vinnolit GmbH & Co. KG, of Ismaning, Germany under the trademark VINNOLIT C 14/50 V. Samples 2 and 3 were PVC/VA copolymers commercially available from Wacker Polymer Systems of Adrian, Mich., under the trademarkd VINNOL 15/45 and VINNOL 40/43, respectively. Also included in each of the compositions was stabilizer at a concentration of about 12 parts per hundred resin and fumed silica at a concentration of about 2 parts per hundred resin. This data is shown graphically in FIG. 5, in which Sample 1 is represented by the data shown as filled diamonds, Sample 2 is represented by the data shown as filled squares and Sample 3 is represented by the data shown as filled triangles.

It is further anticipated that a thermoplastic adhesive in accordance with the principles of the present invention can be formulated from certain mixtures (e.g., mechanical mixtures) of homopolymers such as PVOH, VA, EVA, EAA, PVC, and polyethylene and polypropylene homopolymers and the like. The plasticizers discussed above, e.g., DIDP, DIDA, DNP, DOP, can be used as carrier liquids for such polymer mixtures, as will be recognized by those skilled in the art. It is also anticipated that volatile carrier liquids, such as water, can be used for the mechanically mixed resins.

As discussed above, the unique Theological properties of the thermoplastic adhesive of the present invention result from the low molecular weight characteristics of the resin used, in combination with the plasticizer as a carrier liquid. This is seen even with lower than would be expected levels of plasticizer. To this end, it has been found that the present thermoplastic adhesive remains in a liquid state through heat-up to about 350° F. It is theorized that if high plasticizer levels were in fact needed and used, once cooled, the adhesive would be too soft and gummy to be useful as an adhesive.

In the alternate formulations (i.e., the non-receptor particle containing formulations), heating can be carried out using a simplified heated dispensing head. In such an arrangement, the heat or energy can be provided by an electric heating coil, a steam heater, or by heated air that is provided to the head. Such a heating arrangement is possible because of the unique characteristics of the adhesive being a liquid at room temperature and remaining a pumpable liquid through heat up to application temperature. Those skilled in the art will appreciate the arrangements by which heat can be supplied to or provided by the dispensing head, without undue complexity.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A heat-activated thermoplastic material for forming an adhesive, comprising:
an admixture of a thermoplastic resin in a liquid carrier;
wherein the admixture is a liquid slurry at room temperature that undergoes a change in which the slurry becomes pasty upon heating to a fusion temperature and liquefies upon further heating to form a pumpable molten liquid, the molten liquid hardening as it cools to form an adhesive, the cooled, hardened adhesive being reheatable to return to a liquid state.

2. The thermoplastic material in accordance with claim 1 wherein the thermoplastic resin is a polyvinyl chloride resin.

3. The thermoplastic material in accordance with claim 1 wherein the thermoplastic resin is a copolymer of polyvinyl chloride.

4. The thermoplastic material in accordance with claim 3 wherein the thermoplastic resin is a copolymer of polyvinyl chloride and vinyl acetate.

5. The thermoplastic material in accordance with claim 4 wherein the polyvinyl chloride is present in the thermoplastic resin in a concentration of about 70 percent to about 95 percent and the vinyl acetate is present in a concentration of about 30 percent to about 5 percent.

6. The thermoplastic material in accordance with claim 5 wherein the polyvinyl chloride is present in the thermoplastic resin in a concentration of about 85 percent and the vinyl acetate is present in a concentration of about 15 percent.

7. The thermoplastic material in accordance with claim 1 wherein the thermoplastic resin has a relative viscosity of less than about 1.8.

8. The thermoplastic material in accordance with claim 1 wherein the thermoplastic resin is a copolymer of polypropylene.

9. The thermoplastic material in accordance with claim 1 wherein the thermoplastic resin is a copolymer of polyethylene.

10. The thermoplastic material in accordance with claim 1 wherein the carrier liquid is one of diisodecyl phthlate, diisodecyl adipate, dinonyl phthlate, dioctyl phthlate, tricresyl phosphate and dioctyl adipate.

11. The thermoplastic material in accordance with claim 10 wherein the liquid carrier is diisodecyl phthlate.

12. The thermoplastic material in accordance with claim 1 including at least one additive.

13. The thermoplastic material in accordance with claim 10 wherein the additive is carbon fiber, calcium carbonate, stabilizers, wetting agents, tackifiers, foaming agents, plasticizers or particulate hot-melt adhesive.

14. The thermoplastic material in accordance with claim 1 wherein the thermoplastic resin is present in a concentration of about 46 percent to about 71 percent by weight of the slurry.

15. The thermoplastic material in accordance with claim 14 wherein the thermoplastic resin is present in a concentration of about 60 percent by weight of the slurry.

16. The thermoplastic material in accordance with claim 1 including electromagnetic receptor particles admixed with the thermoplastic resin and the liquid carrier.

17. The thermoplastic material in accordance with claim 16 wherein the electromagnetic receptor particles are ferromagnetic particles, zinc oxide, fumed silica, magnesium aluminum silicate, graphite, carbon black or conductive metal powder.

18. The thermoplastic material in accordance with claim 16 wherein the liquid carrier is a thermally conductive liquid.

19. The thermoplastic material in accordance with claim 1 wherein the liquid carrier is a plasticizer.

20. The thermoplastic material in accordance with claim 19 wherein the plasticizer is present at a level of about 40 parts per hundred resin to about 120 parts per hundred resin.

21. The thermoplastic material in accordance with claim 20 wherein the plasticizer is present at a level of about 120 parts per hundred resin.

22. The thermoplastic material in accordance with claim 18 wherein the thermally conductive liquid is formed from polar molecules.

23. The thermoplastic material in accordance with claim 22 wherein the thermoplastic resin is formed from polar molecules.

24. The thermoplastic material in accordance with claim 16 wherein the thermoplastic adhesive is heated by a high frequency electromagnetic field.

25. The thermoplastic material in accordance with claim 1 wherein the resin is a terpolymer.

26. The thermoplastic material in accordance with claim 25 wherein the terpolymer is a terpolymer of polyvinyl chloride.

27. The thermoplastic material in accordance with claim 26 wherein the terpolymer is a polyvinyl chloride and vinyl acetate.

28. The thermoplastic material in accordance with claim 27 wherein the terpolymer is a polyvinyl chloride/vinyl acetate terpolymer having a functional acid group.

29. The thermoplastic material in accordance with claim 28 wherein the functional acid group is acrylic acid or maleic acid.

30. The thermoplastic material in accordance with claim 28 wherein the functional acid group is present in a concentration of about 1 percent to about 5 percent by weight of the terpolymer.

31. A heat-activated thermoplastic material for forming an adhesive, comprising:
an admixture of a thermoplastic resin in a liquid carrier;
the thermoplastic resin being a copolymer of polyvinyl chloride and vinyl acetate, the polyvinyl chloride being present in a concentration of about 85 percent and the vinyl acetate being present in a concentration of about 15 percent, the thermoplastic resin having a relative viscosity of about 1.8;
the liquid carrier being one of diisodecyl phthlate, diisodecyl adipate, dinonyl phthlate, dioctyl phthlate, tricresyl phosphate and dioctyl adipate;
wherein the thermoplastic resin is present in a concentration of about 60 percent by weight of the slurry and the liquid carrier is present in a concentration of about 40 percent by weight of the slurry and wherein the admixture is a liquid slurry at room temperature that undergoes a change in which the slurry becomes pasty upon heating to a fusion temperature and liquefies upon further heating to form a pumpable molten liquid, the molten liquid hardening as it cools to form an adhesive, the cooled, hardened adhesive being reheatable to return to a liquid state.

32. The thermoplastic material in accordance with claim 31 wherein the liquid carrier is diisodecyl phthlate.

33. The thermoplastic material in accordance with claim 31 including at least one additive.

34. The thermoplastic material in accordance with claim 33 wherein the additive is carbon fiber, calcium carbonate, stabilizers, wetting agents, tackifiers, foaming agents, plasticizers or particulate hot-melt adhesive.

35. The thermoplastic material in accordance with claim 31 wherein the liquid carrier is a plasticizer and wherein the plasticizer is present at a level of about 40 parts per hundred resin to about 120 parts per hundred resin.

36. The thermoplastic material in accordance with claim 35 wherein the plasticizer is present at a level of about 120 parts per hundred resin.

37. An apparatus for dispensing and activating a heat-activated thermoplastic material, comprising:
a reservoir for storing the heat-activated thermoplastic material when in a liquid state;
a nozzle for dispensing the heat activated thermoplastic material when in a liquid state; and
an electromagnetic field generator for generating an electromagnetic field, the generator disposed downstream of the nozzle so that the electromagnetic field acts on the heat activated material after it is dispensed from the nozzle,
wherein when activated, the material becomes pasty upon heating to a fusion temperature and liquefies upon further heating to form a pumpable molten liquid, the molten liquid hardening as it cools to form an adhesive, the cooled, hardened adhesive being reheatable to return to a liquid state.

38. The apparatus in accordance with claim 37 including a pump disposed between the tank and the nozzle for conveying the heat-activated thermoplastic material from the tank to the nozzle.

39. The apparatus in accordance with claim 37 including a dispensing valve disposed between the tank and the nozzle for commencing and terminating flow of the heat-activated thermoplastic material.

40. The apparatus in accordance with claim 38 including a dispensing valve disposed between the pump and the nozzle for commencing and terminating flow of the heat-activated thermoplastic material.

41. The apparatus in accordance with claim 40 including a mixer disposed between the dispensing valve and the pump.

42. The apparatus in accordance with claim 37 wherein the electromagnetic field generator is a coil.

43. A heat-activated thermoplastic material for forming an adhesive, comprising:
an admixture of a thermoplastic resin in a liquid carrier;
wherein the admixture is a liquid slurry at room temperature that undergoes a change in which the slurry becomes remains a pumpable fluid throughout heating to a fusion temperature and liquefies further upon further heating to form a pumpable molten liquid, the molten liquid hardening as it cools to form an adhesive, the cooled, hardened adhesive being reheatable to return to a liquid state, and wherein the thermoplastic resin is a copolymer of polypropylene or polyethylene.

44. A method for converting and applying a thermoplastic material to a substrate comprising the steps of:
providing a thermoplastic material having a rheology wherein the thermoplastic material is a liquid having a first viscosity at a first base temperature, a second viscosity increased from the first viscosity at a second temperature above the first base temperature, a third viscosity reduced from the second viscosity at a third temperature above the second temperature, the thermoplastic material being a pumpable liquid from the fist base temperature through heat up to the third temperature, the thermoplastic material being a solid adhesive at a fourth temperature reduced to at least the first base temperature;
heating the thermoplastic material from the first base temperature through the second temperature to at least the third temperature;
discharging the thermoplastic at the third temperature to a substrate; and
cooling the thermoplastic material to the fourth temperature on the substrate.

45. The method for converting and applying a thermoplastic material in accordance with claim 44 including the step of providing a heat exchanger and heating the thermoplastic material from the first base temperature through the second temperature to the third temperature within the heat exchanger.

46. The method for converting and applying a thermoplastic material in accordance with claim 45 including the step of discharging the thermoplastic material from the heat exchanger onto the substrate.

47. The method for converting and applying a thermoplastic material in accordance with claim 44 wherein the first temperature is about room temperature.

48. The method for converting and applying a thermoplastic material in accordance with claim 44 wherein the third temperature is about 350° F.

49. The method for converting and applying a thermoplastic material in accordance with claim 44 including the steps of:
providing the thermoplastic material with electromagnetic receptor particles; and
heating the thermoplastic material by subjecting it to electromagnetic energy to raise the temperature thereof from the first base temperature through the second temperature to at least the third temperature.

50. The method for converting and applying a thermoplastic material in accordance with claim 49 including the step of providing a discharge nozzle having an electromagnetic energy generator proximal thereto and conveying the thermoplastic material past the electromagnetic energy generator.

51. The method for converting and applying a thermoplastic material in accordance with claim 50 including the step of discharging the thermoplastic material from the discharge nozzle prior to conveying the thermoplastic material past the electromagnetic energy generator.

52. The method for converting and applying a thermoplastic material in accordance with claim 44 wherein the thermoplastic material is an admixture of a thermoplastic resin in a liquid carrier forming a slurry.

53. The method for converting and applying a thermoplastic material in accordance with claim 52 wherein the thermoplastic resin is a copolymer of polyvinyl chloride.

54. The method for converting and applying a thermoplastic material in accordance with claim 53 wherein the thermoplastic resin is a copolymer of polyvinyl chloride and vinyl acetate.

55. The method for converting and applying a thermoplastic material in accordance with claim 54 wherein the polyvinyl chloride copolymer is present in the thermoplastic resin in a concentration of about 70 percent to about 95 percent and the vinyl acetate is present in a concentration of about 30 percent to about 5 percent.

56. The method for converting and applying a thermoplastic material in accordance with claim 55 wherein the polyvinyl chloride copolymer is present in the thermoplastic resin in a concentration of about 85 percent and the vinyl acetate is present in a concentration of about 15 percent.

57. The method for converting and applying a thermoplastic material in accordance with claim 52 wherein the thermoplastic resin has a relative viscosity of less than about 1.8.

58. The method for converting and applying a thermoplastic material in accordance with claim 44 wherein the carrier liquid is one of diisodecyl phthlate, diisodecyl adipate, dinonyl phthlate, dioctyl phthlate, tricresyl phosphate and dioctyl adipate.

59. The method for converting and applying a thermoplastic material in accordance with claim 58 wherein the liquid carrier is diisodecyl phthlate.

60. The method for converting and applying a thermoplastic material in accordance with claim 44 including at least one additive.

61. The method for converting and applying a thermoplastic material in accordance with claim 60 wherein the additive is carbon fiber, calcium carbonate, stabilizers, wetting agents, tackifiers, foaming agents, plasticizers or particulate hot-melt adhesive.

62. The method for converting and applying a thermoplastic material in accordance with claim 52 wherein the thermoplastic resin is present in a concentration of about 46 percent to about 71 percent by weight of the slurry.

63. The method for converting and applying a thermoplastic material in accordance with claim 62 wherein the thermoplastic resin is present in a concentration of about 60 percent by weight of the slurry.

64. The method for converting and applying a thermoplastic material in accordance with claim 52 wherein resin is a terpolymer.

65. The method for converting and applying a thermoplastic material in accordance with claim 64 wherein the terpolymer is a terpolymer of polyvinyl chloride.

66. The method for converting and applying a thermoplastic material in accordance with claim 65 wherein the terpolymer is a polyvinyl chloride and vinyl acetate.

67. The method for converting and applying a thermoplastic material in accordance with claim 66 wherein the terpolymer is a polyvinyl chloride/vinyl acetate terpolymer having a functional acid group.

68. The method for converting and applying a thermoplastic material in accordance with claim 67 wherein the functional acid group is acrylic acid or maleic acid.

69. The method for converting and applying a thermoplastic material in accordance with claim 67 wherein the functional acid group is present in a concentration of about 1 percent to about 5 percent by weight of the terpolymer.
